(19) United States
(12) Patent Application Publication
(10) Pub. No.: US 2021/0018907 A1
(43) Pub. Date: Jan. 21, 2021

(54) MANAGEMENT DEVICE, MANAGEMENT SYSTEM, DISPLAY METHOD, AND PROGRAM

(71) Applicant: Mitsubishi Electric Corporation, Tokyo (JP)

(72) Inventors: Osamu NASU, Tokyo (JP); Ryuichi KATO, Tokyo (JP)

(73) Assignee: Mitsubishi Electric Corporation, Tokyo (JP)

(21) Appl. No.: 17/041,454

(22) PCT Filed: Mar. 30, 2018
(86) PCT No.: PCT/JP2018/013638

§ 371 Date: Sep. 25, 2020

(51) Int. Cl. G05B 23/02; G05B 19/418

(52) U.S. Cl. CPC G05B 23/0297; G05B 19/4185; G05B 23/0272

(57) ABSTRACT

A management apparatus includes a display controller to display a configuration of a system including a management target device and another management target device managed by another management apparatus such that a relationship between the management target devices is indicated. There is a receiver that receives an operation for obtaining device information relating to the management target devices included in the system, and an acquirer that acquires, when the receiver receives an operation for obtaining the device information relating to the management target device, the device information relating to the management target device by reading the device information relating to the management target device from a storage, and acquires, when the receiver receives an operation for obtaining the device information relating to the another management target device managed by the another management apparatus, the device information relating to the another management target device from the another management apparatus.

### TECHNICAL FIELD

The present disclosure relates to a management apparatus, a management system, a display method, and a program.

### BACKGROUND ART

A system in which multiple devices are connected via a network is established in a facility, such as a factory. To operate such system, a management apparatus for management of devices is usually provided (refer to, for example, Patent Literature 1).

Patent Literature 1 discloses a technique for collecting in a database server various data including processing conditions of a control computer and a processing result attained by an inspection computer and for performing centralized control of the collected data. Utilizing the database server by this technique enables management of the computers.

### CITATION LIST

### Patent Literature

Patent Literature 1: Unexamined Japanese Patent Application Publication No. 2007-157061

### SUMMARY OF INVENTION

### Technical Problem

Applying the technique of Patent Literature 1 for a system including numerous devices may cause difficulty in collecting data, because the database server centrally performs data collection processing. Reducing processing load of each server by preparation of multiple database servers is therefore conceivable. However, employing multiple database servers requires additional labor of the user, such as grasping processing target data of each server and searching such data when necessary. Thus there is leeway for reducing the management burden of operating a system including multiple devices.

The present disclosure is made in view of the above-described circumstances, and the objective of the present disclosure is to reduce the management burden of operating a system including multiple devices.

### Solution to Problem

To achieve the aforementioned objective, a management apparatus according to the present disclosure is a management apparatus for connecting to a management target device and to another management apparatus via a network, and includes: display control means for causing display means to display a configuration of a system including the management target device and another management target device managed by the another management apparatus such that a predefined relationship between the management target devices is indicated; reception means for receiving an operation for obtaining device information relating to the management target devices included in the system; and acquisition means for (i) acquiring, when the reception means receives an operation for obtaining the device information relating to the management target device, the device information relating to the management target device by reading the device information relating to the management target device from storage means and (ii) acquiring, when the reception means receives an operation for obtaining the device information relating to the another management target device managed by the another management apparatus, the device information relating to the another management target device from the another management apparatus. The display control means causes the display means to display the device information acquired by the acquisition means.

### Advantageous Effects of Invention

According to the present disclosure, the management apparatus causes the display means to display the configuration of the system such that a predefined relationship between the devices is indicated. Further, upon reception of an operation concerning the management target device, the management apparatus acquires the device information by reading the device information from the storage means, and upon reception of an operation concerning a device that is managed by the another management apparatus, the management apparatus acquires the device information from the another management apparatus and causes the display means to display the acquired information. This enables displaying the configuration of the system for easy understanding by the user and allows the user to obtain the device information relating to any one of the devices without the user grasping a management target range of the management apparatus, thereby reducing the management burden of operating a system including multiple devices.

### BRIEF DESCRIPTION OF DRAWINGS

FIG. 1 is a block diagram illustrating a configuration of a management system according to an embodiment of the present disclosure;

FIG. 2 illustrates a system configuration according the embodiment;

FIG. 3 illustrates a hardware configuration of a management apparatus according to the embodiment;

FIG. 4 illustrates a functional configuration of the management apparatus according to the embodiment;

FIG. 5 illustrates system configuration information according to the embodiment;

FIG. 6 illustrates update status information according to the embodiment;

FIG. 7 illustrates connection information according to the embodiment;

FIG. 8 illustrates an example of a configuration of a device according to the embodiment;

FIG. 9 illustrates device information according to the embodiment;

FIG. 10 is a flowchart of connection information update processing according to the embodiment;

FIG. 11 is a flowchart of response processing according to the embodiment and corresponding to the connection information update processing;

FIG. 12 is a flowchart of UI processing according to the embodiment;

FIG. 13 illustrates a first example of a display screen according to the embodiment;

FIG. 14 is a flowchart of management apparatus addition processing according to the embodiment;

FIG. 15 is a flowchart of change right inquiry processing according to the embodiment;

FIG. 16 is a flowchart of response processing according to the embodiment, the response processing responding to an inquiry;

FIG. 17 is a flowchart of response processing according to the embodiment and corresponding to the management apparatus addition processing;

FIG. 18 is a flowchart of system configuration change processing according to the embodiment;

FIG. 19 is a flowchart of response processing according to the embodiment and corresponding to the system configuration change processing;

FIG. 20 is a flowchart of device information reading processing according to the embodiment;

FIG. 21 illustrates a second example of the display screen according to the embodiment;

FIG. 22 is a flowchart of response processing according to the embodiment and corresponding to the device information reading processing;

FIG. 23 illustrates a third example of the display screen according to the embodiment;

FIG. 24 is a flowchart of device information change processing according to the embodiment;

FIG. 25 is a flowchart of response processing according to the embodiment and responding to changing of the device information; and

FIG. 26 illustrates a modified example of the display screen.

### DESCRIPTION OF EMBODIMENTS

Hereinafter, a management system 100 according to an embodiment of the present disclosure is described in detail with reference to the drawings.

### Embodiment

The management system 100 according to the embodiment is a factory automation (FA) system installed in a factory and is equivalent to a production system for producing products. This management system 100 performs, for a work piece flowing on a line X that is a production line, various processing such as working, monitoring, and inspection. The management system 100 has a function that allows a user U1 to manage a state of a system.

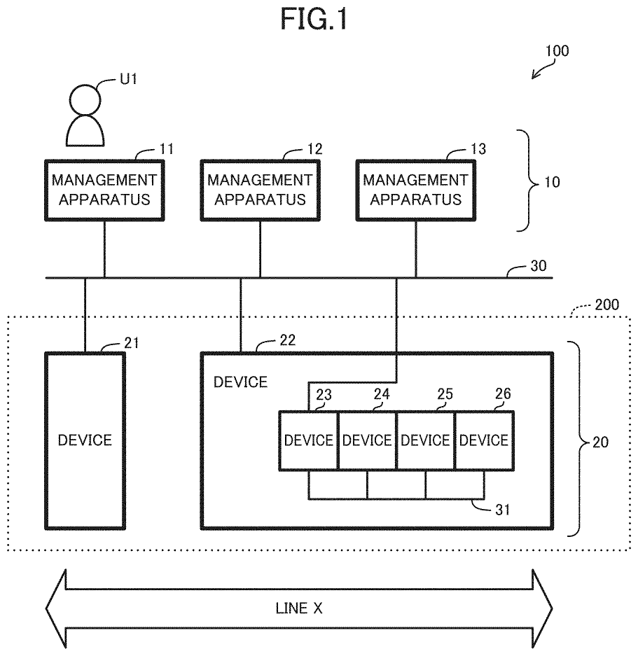

As illustrated in FIG. 1, the management system 100 includes management apparatuses 11, 12, and 13 that manage devices 21, 22, 23, 24, 25, and 26, and the devices 21 and 22 connected to the management apparatuses 11, 12, and 13 via a network 30. The device 22 includes the device 23 and the devices 24, 25, and 26 connected to the device 23 via a bus 31.

The network 30 is an industrial network. The management apparatuses 11-13 and the devices 21-23 are communicatably connected to one another via the network 30. Additionally, the management apparatuses 11-13 and the devices 24-26 are communicatably connected to one another via the device 23 connected to the network 30.

The devices 21-26 are devices such as an actuator and a robot.

The management apparatuses 11-13 manage a system 200 that includes the devices 21-26. Specifically, the management apparatus 11 manages the device 21, the management apparatus 12 manages the device 22, and the management apparatus 13 manages the devices 23-26. Each of the management apparatuses 11-13 manages devices other than management target of the corresponding management apparatus via the management apparatuses of management apparatuses 11-13 other than the corresponding management apparatus. For example, the management apparatus 11 does not directly treat the device 22 as the management target, and instead manages via the management apparatus 12.

Hereinafter, the management apparatuses 11-13 are collectively termed and referred to as management apparatuses 10. Additionally, the devices 21-26 are collectively termed and referred to as devices 20.

The management apparatus 10 provides a user interface that allows the user U1 to easily manage all of the devices 21-26 by operating any of the management apparatuses 10 without taking into consideration management targets of each management apparatus 10.

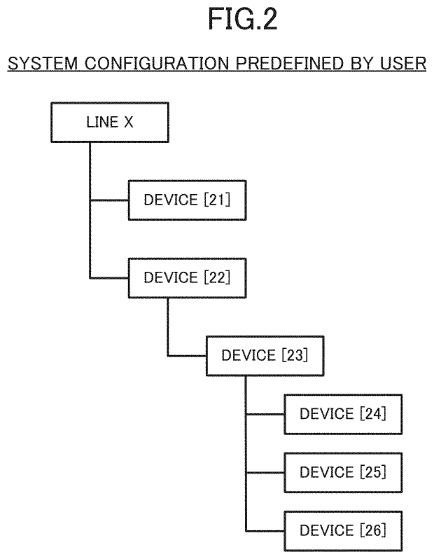

Specifically, all of the management apparatuses 10 share a system configuration predefined by a user, as illustrated in FIG. 2. This system configuration is defined in a format including master-slave relationships among the devices. FIG. 2 shows, for example, that the device 23 is subordinate to the device 22, and the devices 24-26 are subordinate to the device 23. The management apparatuses 10 display such system configuration to the user in a tree-like structure to enable easy acquiring and editing of information relating to each device. In FIG. 2, the numbers followed by “DEVICE” each indicate a reference sign of the corresponding device included in the devices 20. For example, “DEVICE [21]” corresponds to the device 21. The system configuration is defined freely from actual (physical) connection relationships among the devices 20 and a management target range of each of the management apparatuses 10.

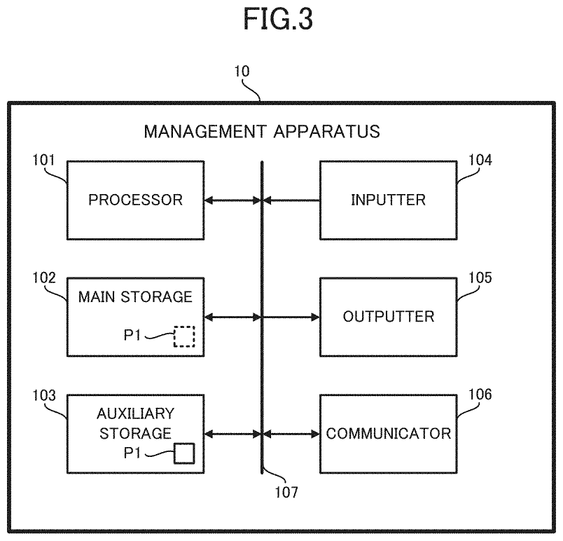

Next, a hardware configuration of the management apparatus 10 is described. As illustrated in FIG. 3, the management apparatus 10 includes a processor 101, a main storage 102, an auxiliary storage 103, an inputter 104, an outputter 105 and a communicator 106. The main storage 102, the auxiliary storage 103, the inputter 104, the outputter 105 and the communicator 106 are connected to the processor 101 via an internal bus 107.

The processor 101 includes a micro processing unit (MPU). The processor 101 executes a program P1 stored in the auxiliary storage 103 to achieve various functions of the management apparatus 10, thereby executing processing described later.

The main storage 102 includes a random access memory (RAM). The program P1 is loaded from the auxiliary storage 103 into the main storage 102. The main storage 102 is used by the processor 101 as a work area.

The auxiliary storage 103 includes a nonvolatile memory such as an electrically erasable programmable read-only memory (EEPROM). The auxiliary storage 103 stores the program P1 and various data to be used for processing by the processor 101. The auxiliary storage 103 supplies, in accordance with instructions from the processor 101, to the processor 101 data to be used by the processor 101 and stores data supplied from the processor 101.

The inputter 104 includes an input device such as input keys and a pointing device. The inputter 104 acquires information input by the user U1 of the management apparatus 10 and sends notification of the acquired information to the processor 101.

The outputter 105 includes an output device such as a liquid crystal display (LCD) and a speaker. The outputter 105 is configured as a touchscreen formed integrally with the pointing device included in the inputter 104. The outputter 105 presents, in accordance with instructions from the processor 101, various information for the user U1.

The communicator 106 includes a network interface circuit for communicating with an external device. The communicator 106 receives a signal from the exterior and outputs data indicated by the signal to the processor 101. Furthermore, the communicator 106 transmits to the external device a signal indicating data output from the processor 101.

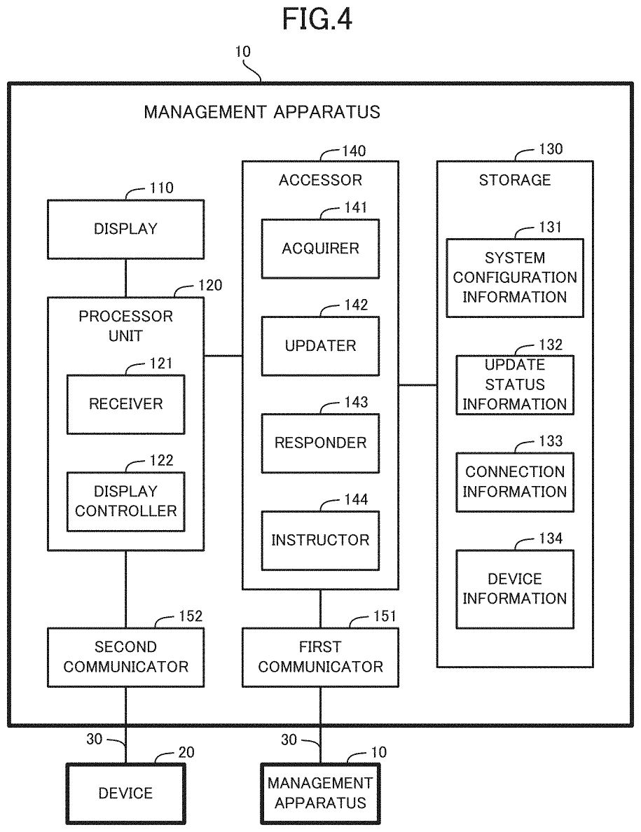

The management apparatus 10 achieves various functions by cooperation among the above-described hardware components. As illustrated in FIG. 4, the management apparatus 10 functionally includes a display 110 for operation by the user U1 of the management apparatus 10, a processor unit 120 that executes data processing for management of the devices 20, a storage 130 that stores various data, an accessor 140 that accesses the storage 130 and another management apparatus 10, a first communicator 151 for communicating with another management apparatus 10, and a second communicator 152 for communicating with the devices 20 that are the management targets.

The display 110 is equivalent to a touch screen that is mainly achieved by corporation of the inputter 104 and the outputter 105. The display 110 generates a display screen in accordance with instructions from the processor unit 120. Also, the display 110 provides notification of content of an operation input by the user U1 to the processor unit 120. The display 110 functions as the display means in the claims.

The processor unit 120 is mainly achieved by the processor 101. The processor unit 120 executes data processing for providing a user interface to the user U1. The processor unit 120 includes a receiver 121 that receives an operation from the user U1 and a display controller 122 that controls the display 110.

The processor unit 120 executes processing based on the operation that the receiver 121 receives. This processing includes controlling the accessor 140, managing the devices 20 that are the management targets via the second communicator 152, and controlling the display 110 by use of the display controller 122. The display controller 122 generates display data for displaying a screen in accordance with an operation by the user U1 and sends the display data to the display 110, thereby causing the display 110 to display various information. The receiver 121 functions as the reception means in the claims, and the display controller 122 functions as the display control means in the claims.

The storage 130 is mainly achieved by the auxiliary storage 103. The storage 130 stores data including: system configuration information 131 indicating a configuration of the system 200, update status information 132 indicating update status of the system configuration information 131, connection information 133 indicating status of connection with the other management apparatuses 10, and device information 134 relating to the devices that are included in the devices 20 and are the management targets of the local management apparatus 10. The storage 130 functions as the storage means in the claims.

The system configuration information 131 defines the configuration of the system 200 including the devices 20 in a format specifying master-slave relationships among the devices 20. The system configuration information 131 is used for displaying the system configuration in a tree-like structure. Also, the system configuration information 131 indicates information of management targets of each management apparatus 10.

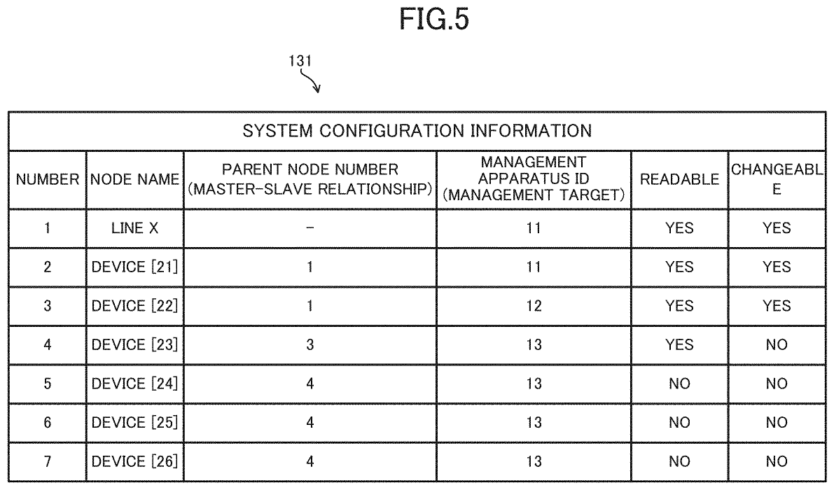

As illustrated in FIG. 5, the system configuration information 131 is data in table format in which a line data number, a node name of a node included in the system 200, a parent node number of the node, an ID of the management apparatus 10 that manages the device 20 corresponding to the node, and readability and changeability of information relating to this device 20 from another management apparatus 10 are associated with one another. The nodes are nodes that achieve connection relationships in a tree-like structure as illustrated in FIG. 2, and correspond to the devices 20. The IDs of the management apparatuses 10 each correspond to the reference sign of the corresponding management apparatus 10 of FIG. 1.

The node name is not limited to a name indicating the device 20. The node name may be a name indicating a location of a factory or a line in which the device 20 is installed, or may be a name indicating the function of the device 20 in the line X, such as “conveyer” or “cutter”.

The parent node number designates a number of the line data, thereby indicating a parent node to which the node is subordinate, and indicating master-slave relationships among the nodes. For example, the line data in the line denoted by the number “4” indicates that the master of the device 23 is the device 22 of the line data in the line denoted by the number “3”. By referring to the parent node numbers of the line data in the lines denoted by the numbers “1”-“7”, the system configuration illustrated in FIG. 2 can be displayed in a tree-like structure. Although the top node is “LINE X” for easy understanding by the user U1 of the system configuration, the top node is not limited to line X. The top node may be a name of the system 200, or the top node may be left unspecified by use of an empty data field.

The line data in the line denoted by the number “4” indicates that the device 23 is the management target of the management apparatus 13, and information relating to the device 23 is readable but is unchangeable from the management apparatuses other than the management apparatus 13 (the management apparatuses 11, 12). Information relating to each device 20 is readable and is changeable from the management apparatus 10 of which management target is the device 20.

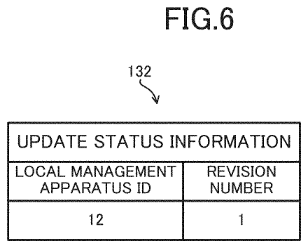

Again with reference to FIG. 4, the update status information 132 indicates an update status of the system configuration information 131 stored in the storage 130. As illustrated in FIG. 6, the update status information 132 is data in table format in which a local management apparatus ID of the management apparatus 10 and a revision number of the system configuration information 131 stored in the storage 130 of the management apparatus 10. The indicated revision number increases with newness of the update reflected in the system configuration information 131. The update status information 132 is utilized to update the system configuration information 131 stored in each management apparatus 10 to a newest state.

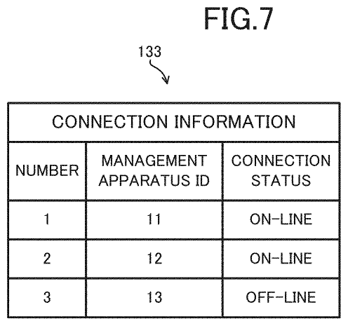

Again with reference to FIG. 4, the connection information 133 indicates whether each of the management apparatuses 10 establishes a connection with the network 30. As illustrated in FIG. 7, the connection information 133 is data in table format in which a line data number, an ID of the management apparatus 10, and connection status of the management apparatus 10 are associated with one another. Each of the management apparatus 10 updates the connection information 133 by monitoring the network 30. When the management apparatus 10 does not establish a connection with the network 30, the device 20 that is the management target of the management apparatus 10 cannot be managed from another management apparatus 10. The connection information 133 is used for displaying to the user U1 whether the devices 20 are manageable or not.

Again with reference to FIG. 4, the device information 134 is information relating to the devices 20 that are the management target of the management apparatus 10. The device information 134 includes configurations of terminal devices including a sensor and a motor included in the devices 20, and information relating to the other devices 20.

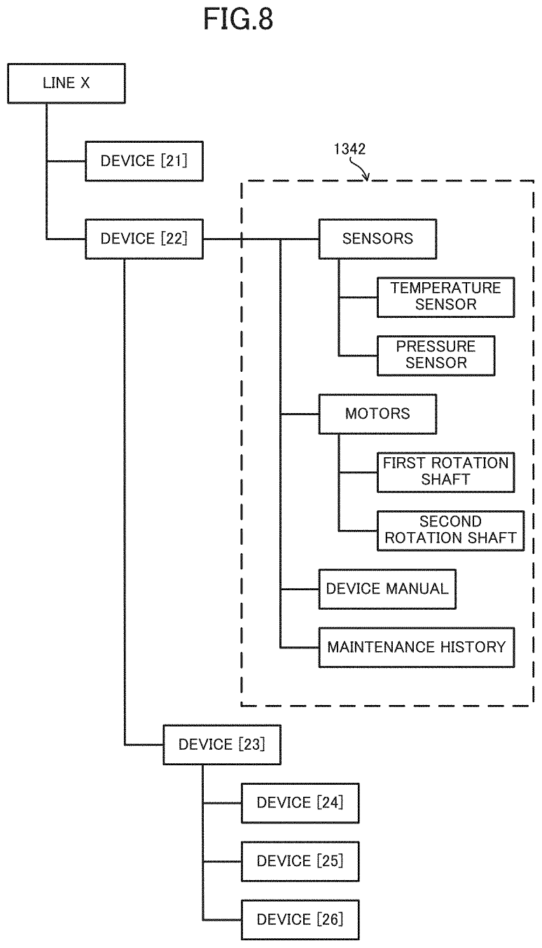

FIG. 8 illustrates, as an example of content included in the device information 134, device information 1342 relating to the device 22. As illustrated in FIG. 8, the device 22 includes sensors including a temperature sensor and a pressure sensor, and motors including a first rotation shaft and a second rotation shaft. The device information 1342 includes a device manual and a maintenance history. By selecting in the system configuration illustrated in FIG. 2 the icon indicating the device 22, the device information 1342 as illustrated in FIG. 8 is displayed to the user U1 in a tree-like structure.

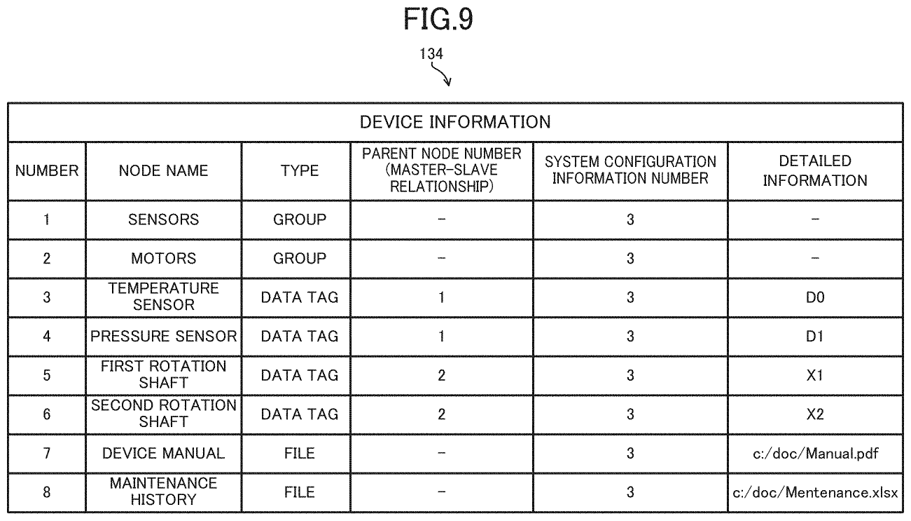

FIG. 9 illustrates the device information 134 stored in the storage 130. As illustrated in FIG. 9, the device information 134 is data in table format in which a line data number, a node name, a type of the node, a number of a parent node of the node, a line number of the system configuration information 131 that corresponds to the device 20 relating to the device information 134, and detailed information of the node are associated to one another.

Among the node types, “group” indicates that the node is a group including other nodes, “data tag” indicates that the node is an terminal device for inputting and outputting data, and “file” indicates that the node is data that is related to the device 20 and is stored in the storage 130. The parent node number, similarly to the parent node number of FIG. 5, indicates a master-slave relationship between the nodes and is used for displaying in a tree-like structure. The number of the system configuration information 131 indicates to which device 20 the device information 134 information is related, and in the example illustrated in FIG. 8, corresponds to “device [22]” denoted by the device information 1342. In FIG. 9, when the number of the system configuration information 131 is specified to be “3”, upon reference to FIG. 5, the line number “3” corresponds to the device 22, and thus the device information 134 illustrated in FIG. 9 is understood to be information relating to the device 22.

Again with reference to FIG. 4, the accessor 140 is mainly achieved by the processor 101. The accessor 140 accesses various information used for processing executed by the processor unit 120. Then the accessor 140 reads the information, sends notification of the information to the processor unit 120, and rewrites information of an access destination in accordance with an instruction from the processor unit 120. The accessor 140 includes an acquirer 141 that acquires information, an updater 142 that updates information, a responder 143 that responds to a request from another management apparatus 10, and an instructor 144 that instructs another management apparatus 10.

The acquirer 141 acquires the information stored in the storage 130 by reading the information from the storage 130, and acquires the device information 134 relating to the device 20 that is the management target of another management apparatus 10 by requesting such from the another management apparatus 10. The acquirer 141 functions as the acquisition means in the claims.

The updater 142 updates the information stored in the storage 130 in accordance an operation performed by the user U1. The updater 142, when another management apparatus 10 requests updating of the device information 134 stored in the storage 130, updates the device information 134. Further, when the content of the system configuration information 131 stored in the storage 130 differs from the content of the system configuration information 131 stored in another management apparatus 10, the updater 142 updates the system configuration information 131 stored in the storage 130. The updater 142 functions as the update means in the claims.

When another management apparatus 10 requests providing of the device information 134 stored in the storage 130, the responder 143 provides the device information 134 in response to the request. Further, when another management apparatus 10 requests sending of notification of a connection status, the responder 143 responds to the request. The responder 143 functions as the response means in the claims.

When the user U1 performs an operation via the display 110 to change the device information 134 relating to the device 20 that is managed by another management apparatus 10, the instructor 144 instructs the other management apparatuses 10 to change the device information 134 in accordance with the operation. The instructor 144 functions as the instruction means in the claims.

The first communicator 151 and the second communicator 152 are mainly achieved by the communicator 106. The first communicator 151 transmits and receives data between the accessor 140 and another management apparatus 10. The second communicator 152 transmits data to, and receives data from, the processor unit 120 and the devices 20 that are the management targets.

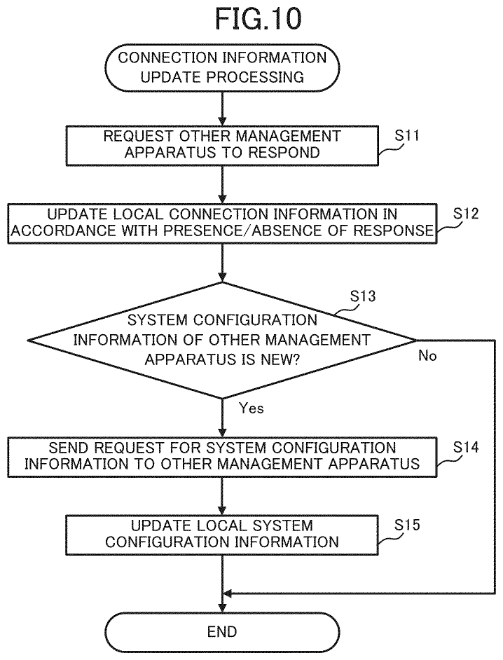

Next, connection information update processing and user interface (UI) processing that are executed by the management apparatuses 10 are described in turn with reference to FIGS. 10-25. FIG. 10 is a flowchart illustrating the connection information update processing. This connection information update processing is processing for updating the connection information 133 and is executed periodically, for example, with a thirty second intervals.

In the connection information update processing, the management apparatus 10 (hereinafter referred to as “the one management apparatus 10”) requests the other management apparatuses 10 to respond (step S11). Specifically, the updater 142 performs unicast communication via the first communicator 151 to confirm presence of the other management apparatuses 10 on the network 30. All of the management apparatuses 10 indicated by the system configuration information 131 are communication subjects in the unicast communication.

Then the updater 142 updates the local connection information 133 of the one management apparatus 10 in accordance with presence/absence of responses from the other management apparatuses 10 (step S12). This response includes the revision numbers of the system configuration information 131 stored in the other management apparatuses 10. The updater 142 reads the update status information 132 stored in the storage 130 and compares the revision number included in the read update status information 132 and the revision numbers included in the responses from the other management apparatuses 10. Then the updater 142 determines whether the system configuration information 131 of the other management apparatuses 10 is new (step S13).

When the determination in step S13 is negative (No in step S13), the connection status update processing ends. Conversely, when the determination in step S13 is positive (Yes in step S13), the updater 142 sends a request for the system configuration information 131 to the other management apparatuses 10 (step S14). Then the updater 142 replaces older information stored in the storage 130 with the system configuration information 131 from the other management apparatuses 10, thereby updating the system configuration information 131 to a newest state (step S15). Thereafter, the connection status update processing ends.

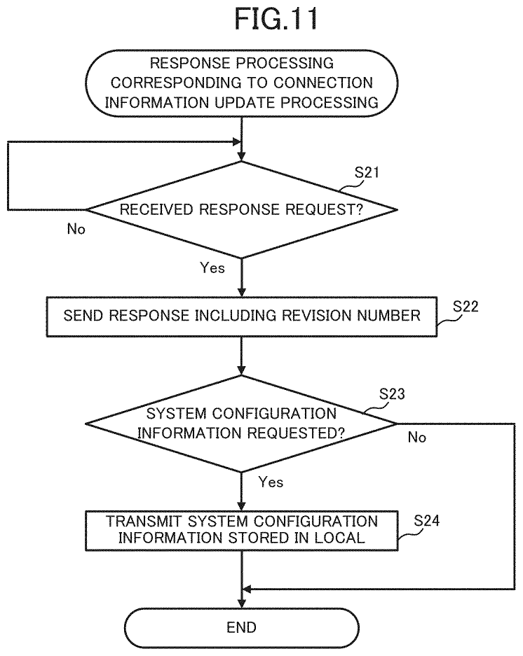

Next, response processing that is executed by each of the other management apparatuses 10 (hereinafter referred to as “the other management apparatus 10”) when the one management apparatus 10 executes the connection status update processing is described with reference to FIG. 11. In this response processing, the other management apparatus 10 determines whether a response request is received (step S21). Specifically, the responder 143 of the other management apparatus 10 determines whether the request made in step S11 of FIG. 10 is received.

When a determination is made that the response request is not received (No in step S21), the other management apparatus 10 waits until the response request is received. Conversely, when a determination is made that the response request is received (Yes in step S21), the other management apparatus 10 sends a response to the response request, including the revision number (step S22). Specifically, the responder 143 reads the revision number from the storage 130 and transmits, to the one management apparatus 10 that is the transmission source of the response request, via the first communicator 151, a packet including the revision number.

Then the other management apparatus 10 determines whether the system configuration information 131 is requested (step S23). Specifically, the responder 143 determines whether the request made in step S14 of FIG. 10 is received. When a determination is made that the system configuration information 131 is not requested (No in step S23), the response processing ends. Conversely, when a determination is made that the system configuration information 131 is requested (Yes in step S23), the other management apparatus 10 transmits the local system configuration information 131 stored therein to the one management apparatus 10 that is the transmission source of the request (step S24). Specifically, the responder 143 of the other management apparatus 10 reads the system configuration information 131 from the storage 130 and transmits, to the one management apparatus 10 that is the transmission source of the response request, via the first communicator 151, this system configuration information 131. Thereafter, the response processing ends.

Executing the connection information update processing and the response processing that are described above allows each management apparatus 10 to monitor the connection status of the management apparatuses 10 other than the corresponding management apparatus 10.

Next, the UI processing executed by the management apparatuses 10 is described. The UI processing is processing for achieving a UI that allows the user U1 to manage all of the devices 20 included in the system 200 using a freely selected one of the management apparatuses 10.

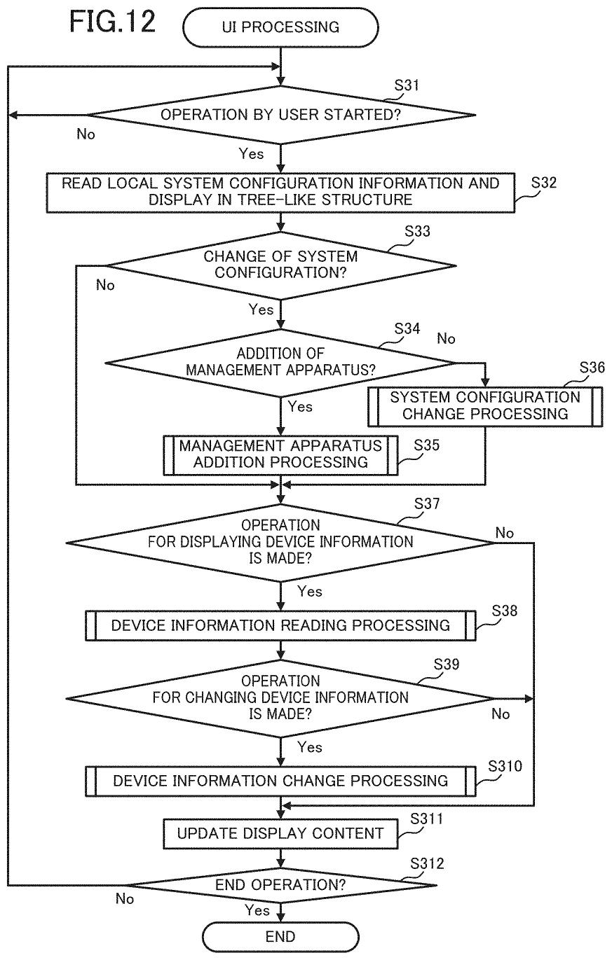

As illustrated in FIG. 12, in the UI processing, the management apparatus 10 (hereinafter referred to as “the one management apparatus 10”) determines whether operation by the user U1 is started (step S31). Specifically, the processor unit 120 determines whether a program for displaying information on the screen of the display 110 is executed by an operation by the user U1.

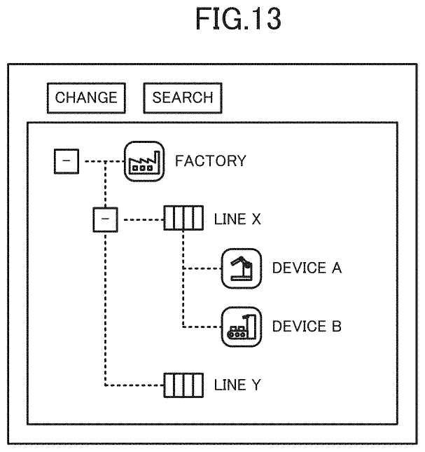

When a determination is made that the operation by the user U1 is not started (No in step S31), the one management apparatus 10 repeats determining in step S31. Conversely, when a determination is made that the operation by the user U1 is started (Yes in step S31), the one management apparatus 10 reads the local system configuration information 131 from the storage 130 and displays the system configuration on the display 110 (step S32). Specifically, the display controller 122 causes the display 110 to display the configuration of the system 200 such that the master-slave relationships among the devices 20 are indicated. This allows the display 110 to display a screen as illustrated in FIG. 13. In this screen, the system configuration is described using icons and node names, and the master-slave relationships are described using dashed lines.

Then the one management apparatus 10 determines whether an operation for changing the system configuration is input by the user U1 (step S33). The changing of the system configuration includes changing of the master-slave relationships and addition of a new management apparatus 10.

When the determination in step S33 is negative (No in step S33), the processing executed by the one management apparatus 10 shifts to step S37. Conversely, when the determination in step S33 is positive (Yes in step S33), the one management apparatus 10 determines whether the content of the operation is the addition of the new management apparatus 10 (step S34).

When the determination in step S34 is positive (Yes in step S34), the one management apparatus 10 executes addition processing for addition of the new management apparatus 10 to the system configuration information 131 (step S35) and then shifts the processing to step S37. Conversely, when the determination in step S34 is negative (No in step S34), the one management apparatus 10 executes change processing for changing the system configuration (step S36) and then shifts the processing to step S37.

Here, the addition processing in step S35 and the change processing in step S36 are described in turn. The addition processing and the change processing are mainly executed by the updater 142 of the one management apparatus 10.

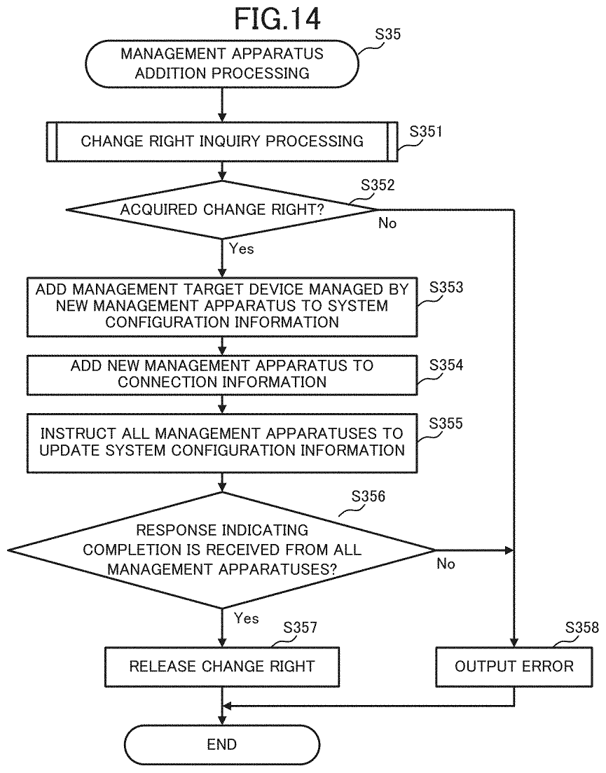

As illustrated in FIG. 14, in the addition processing for adding the new management apparatus 10, the one management apparatus 10 executes inquiry processing for inquiring about a change right to change the system configuration information 131 (step S351). Although each of the management apparatuses 10 stores the system configuration information 131, all of the management apparatuses 10 synchronously share the content of the system configuration information 131. Thus conflicting content may occur during updating of the system configuration information 131 by multiple management apparatuses 10 at the same time. To avoid the occurrence of such conflict, the updating of the system configuration information 131 is limited to the one management apparatuses 10 that acquires the change right, and the inquiry processing is executed for acquisition of the change right. The inquiry processing is executed mainly by the updater 142 as pre-processing of the updating processing of the system configuration information 131.

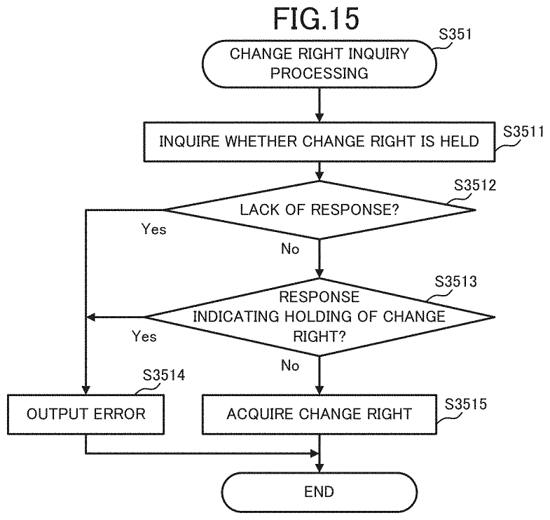

As illustrated in FIG. 15, in the inquiry processing for inquiring about the change right, the one management apparatus 10 inquires of the other management apparatuses 10 as to whether the change right is held (step S3511).

Then the one management apparatus 10 determines whether a response to the inquiry in step S3511 is received (step S3512). When a determination is made that the response is received (No in step S3512), the one management apparatus 10 determines whether the response from the other management apparatuses 10 is a response indicating holding of the change right (step S3513). When a determination is made in step S3512 that a response is not received (Yes in step S3512) or when a determination is made in step S3513 that the response indicates holding of the change right (Yes in step S3513), the one management apparatus 10 outputs an error (step S3514) and ends the inquiry processing.

When a determination is made in step S3513 that the response does not indicate holding of the change right (No in step S3513), the one management apparatus 10 determines that the change right is released, and thus acquires the change right (step S3515). Thereafter, the inquiry processing ends.

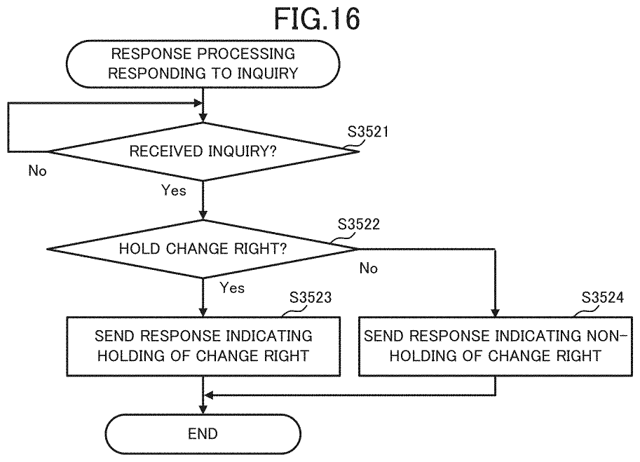

Next, response processing that is executed by each of the other management apparatuses 10 (hereinafter referred to as “the other management apparatus 10”) when the one management apparatus 10 executes the inquiry processing is described with reference to FIG. 16. This response processing is executed by the responder 143 of the other management apparatus 10. In the response processing, the other management apparatus 10 determines whether the inquiry is received (step S3521). Specifically, the responder 143 of the other management apparatus 10 determines whether the inquiry made in step S3511 of FIG. 15 is received.

When a determination is made that the inquiry is not received (No in step S3521), the other management apparatus 10 waits until the inquiry is received. Conversely, when a determination is made that the inquiry is received (Yes in step S3521), the other management apparatus 10 determines whether the other management apparatus 10 holds the change right (step S3522).

When a determination is made that the change right is held (Yes in step S3522), the other management apparatus 10 sends, to the one management apparatus 10 from which the inquiry is made, a response indicating holding of the change right (step S3523), and then ends the response processing. Conversely, When a determination is made that the change right is not held (No in step S3522), the other management apparatus 10 sends, to the one management apparatus 10 from which the inquiry is made, a response indicating non-holding of the change right (step S3524), and then ends the response processing.

As a result of execution of the inquiry processing and the response processing, only one management apparatus 10 of all the management apparatuses 10 acquires the change right.

Again with reference to FIG. 14, following step S351, the one management apparatus 10 determines whether the change right is acquired (step S352). When a determination is made that the change right is acquired (Yes in step S352), the one management apparatus 10, in accordance with an operation by the user, adds to the system configuration information 131 a device that is a management target of the new management apparatus 10 (step S353). Also, the one management apparatus 10 adds the new management apparatus 10 to the connection information 133 (step S354).

Then the one management apparatus 10 transmits the system configuration information 131 updated by the one management apparatus 10 to the other management apparatuses 10 and gives an instruction to update the system configuration information 131 (step S355). This instruction is performed by the instructor 144. Then the one management apparatus 10 determines whether responses indicating completion of update of the system configuration information 131 are received from all the other management apparatuses 10 (step S356).

When the determination in step S356 is positive (Yes in step S356), the one management apparatus 10 releases the change right (step S357) and ends the addition processing. Conversely, when the determination in step S356 is negative (No in step S356) or when a determination is made in step S352 that the change right is not acquired (No in step S352), the one management apparatus 10 outputs an error (step S358) and ends the addition processing.

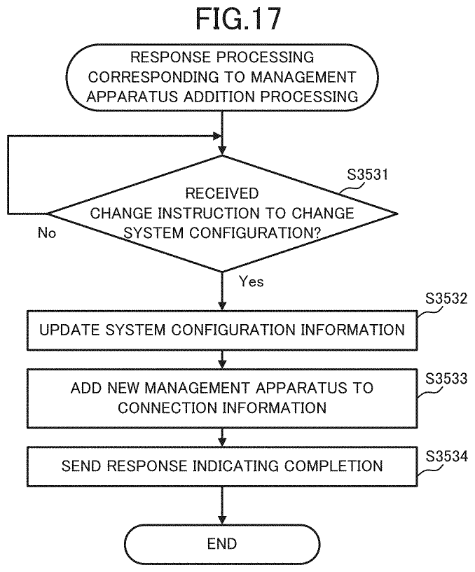

Next, response processing that is executed by the other management apparatus 10 when the one management apparatus 10 executes the addition processing for addition of the new management apparatus 10 to the system configuration information 131 is described with reference to FIG. 17.

In this response processing, the other management apparatus 10 determines whether a change instruction to provide instruction to change the system configuration is received (step S3531). Specifically, the responder 143 of the other management apparatus 10 determines whether the instruction instructing updating and made in step S355 of FIG. 14 is received. When a determination is made that the change instruction is not received (No in step S3531), the other management apparatus 10 repeats determining in step S3531.

Conversely, when a determination is made that the change instruction is received (Yes in step S3531), the updater 142 of the other management apparatus 10 updates the system configuration information 131 in accordance with the instruction (step S3532). Also, the updater 142 of the other management apparatus 10 adds the new management apparatus 10 to the connection information 133 (step S3533).

Then the responder 143 of the other management apparatus 10 sends, to the one management apparatus 10 from which the instruction is transmitted, a response indicating completion of change of the system configuration information 131 (step S3534). This response is equivalent to the response serving as the subject of the determination in step S356 of FIG. 14. Thereafter, the response processing ends.

Execution of the addition processing of adding a new management apparatus 10 and the response processing allows, when the new management apparatus 10 is added to the system configuration indicated by the system configuration information 131 by operating any one of the management apparatuses 10, reflecting the addition of the new management apparatus 10 in all the system configuration information 131 stored in the management apparatuses 10.

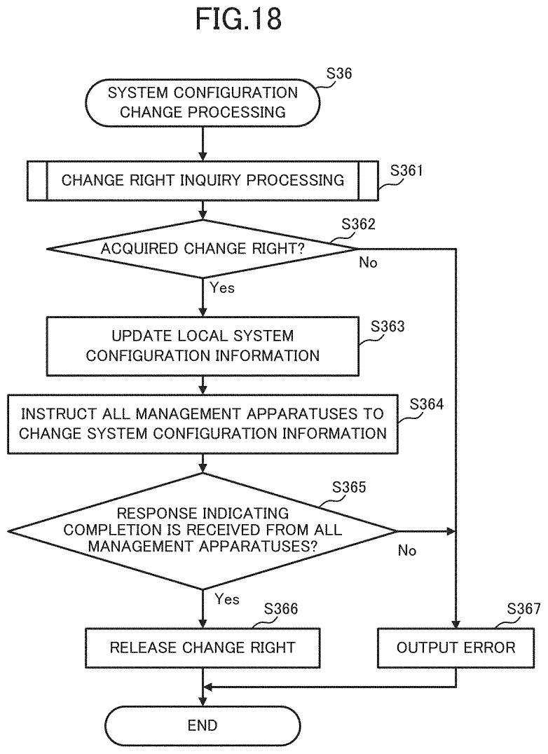

Next, the system configuration change processing of FIG. 12 (step S36) is described with reference to FIG. 18. In this change processing, the one management apparatus 10 executes inquiry processing for inquiring about the change right (step S361). In this inquiry processing, processing that is equivalent to the flowchart of FIG. 15 is executed. Also, the other management apparatus 10 executes, as response processing responding to the inquiry, processing that is equivalent to the flowchart of FIG. 16.

Then the one management apparatus 10 determines whether the change right is acquired (step S362). When a determination is made that the change right is acquired (Yes in step S362), the one management apparatus 10 updates the system configuration information 131 in accordance with an operation by the user (step S363).

Then the one management apparatus 10 transmits the system configuration information 131 updated by the one management apparatus 10 to the other management apparatuses 10 and gives an instruction for updating the system configuration information 131 (step S364). Then the one management apparatus 10 determines whether responses indicating completion of update of the system configuration information 131 are received from the other management apparatuses 10 (step S365).

When the determination in step S365 is positive (Yes in step S365), the one management apparatus 10 releases the change right (step S366) and ends the change processing. Conversely, when the determination in step S365 is negative (No in step S365) or when a determination is made in step S362 that the change right is not acquired (No in step S362), the one management apparatus 10 outputs an error (step S367) and then ends the change processing.

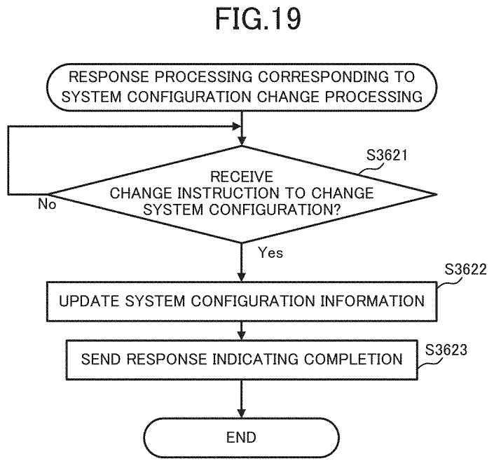

Next, response processing that is executed by the other management apparatus 10 when the one management apparatus 10 executes the change processing for changing the system configuration information 131 is described with reference to FIG. 19.

In this response processing, the other management apparatus 10 determines whether a change instruction giving an instruction for changing the system configuration is received (step S3621). Specifically, the responder 143 of the other management apparatus 10 determines whether the instruction giving an instruction for updating and made in step S364 of FIG. 18 is received. When a determination is made that the change instruction is not received (No in step S3621), the other management apparatus 10 repeats determining in step S3621.

Conversely, when a determination is made that the change instruction is received (Yes in step S3621), the updater 142 of the other management apparatus 10 updates the system configuration information 131 in accordance with the instruction (step S3622).

Then the responder 143 of the other management apparatus 10 sends, to the one management apparatus 10 from which the instruction is transmitted, a response indicating completion of change of the system configuration information 131 (step S3623). This response is equivalent to the response serving as the subject of the determination in step S365 of FIG. 18. Thereafter, the response processing ends.

Execution of the change processing for changing the system configuration and the response processing allows, when the system configuration information 131 is changed by operating one of the management apparatuses 10, reflecting the content of the change in all the system configuration information 131 stored in the management apparatuses 10.

Again with reference to FIG. 12, following steps S35 and S36, the one management apparatus 10 determines whether a display operation for displaying the device information 134 is made by the user U1 (step S37). This operation is an operation by the user for obtaining the device information 134 and is, for example, an operation of selecting the icon of FIG. 13.

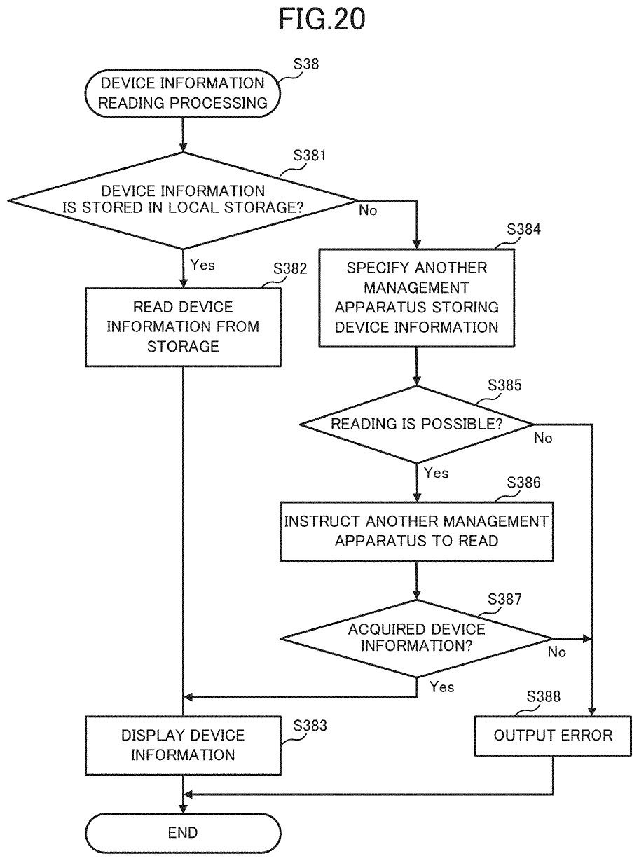

When a determination is made that the display operation is not made (No in step S37), the one management apparatus 10 shifts the processing to step S311. Conversely, when a determination is made that the display operation is made (Yes in step S37), the one management apparatus 10 executes reading processing of reading the device information 134 (step S38). Hereinafter, this reading processing is described with reference to FIG. 20.

In the reading processing, the one management apparatus 10 determines whether the device information 134 to be read is stored in the storage 130 thereof (step S381). When a determination is made that the to-be-read device information 134 is stored in the storage 130 of the one management apparatus 10 (Yes in step S381), the acquirer 141 of the one management apparatus 10 acquires the to-be-read device information 134 by reading the device information 134 from the storage 130.

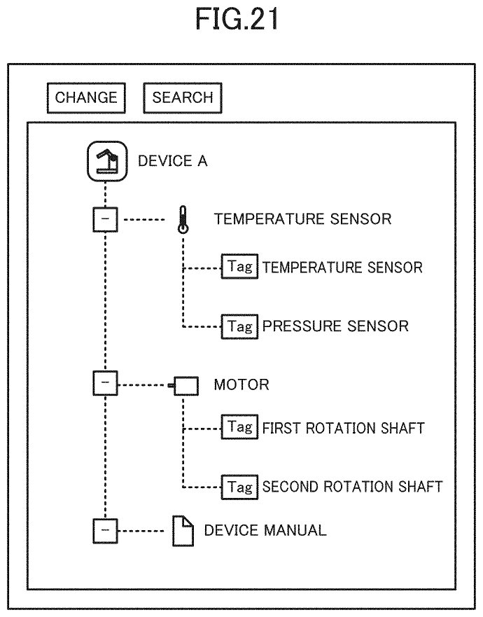

Then the one management apparatus 10 displays the device information 134 (step S383). Specifically, the display controller 122 causes the display 110 to display, in a tree-like structure, the content of the device information 134 acquired by the acquirer 141. This allows the display 110 to display the screen as illustrated in FIG. 21. Thereafter, the reading processing ends.

When a determination is made in step S381 that the to-be-read device information 134 is not stored in the storage 130 of the one management apparatus 10 (No in step S381), the acquirer 141 of the one management apparatus 10 refers to the system configuration information 131 to specify another management apparatus 10 that stores the to-be-read device information 134 (step S384).

Then the one management apparatus 10 determines whether reading of the to-be-read device information 134 is possible (step S385). Specifically, the acquirer 141 refers to the system configuration information 131 and determines whether reading of the to-be-read device information 134 is possible by use of the one management apparatus 10 that does not directly manage the device 20.

When the reading is determined to be possible (Yes in step S385), the instructor 144 instructs the another management apparatus 10 to read the to-be-read device information 134 (step S386). Then the acquirer 141 determines whether the to-be-read device information 134 is acquired from the another management apparatus 10 (step S387).

When a determination is made that the to-be-read device information 134 is acquired (Yes in step S387), the one management apparatus 10 shifts the processing to step S383. When the reading is determined to be impossible in step S385 (No in step S385) or when a determination is made in step S387 that the to-be-read device information 134 is not acquired (No in step S387), the one management apparatus 10 outputs an error (step S388) and ends the reading processing.

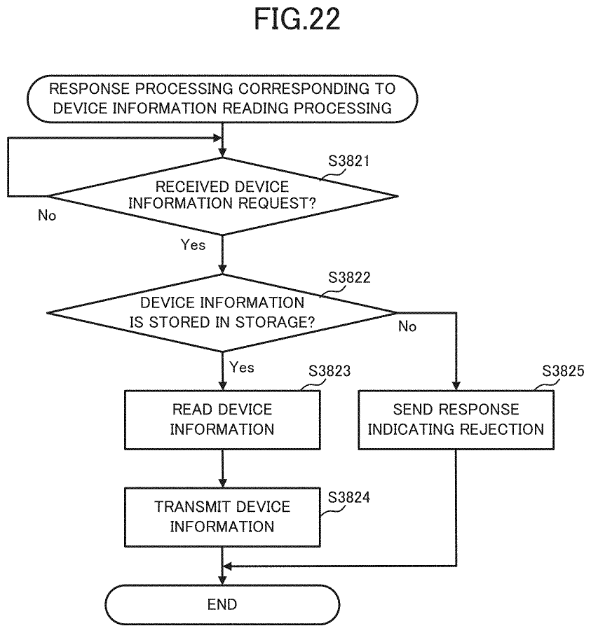

Next, response processing that is executed by the other management apparatus 10 when the to-be-read device information 134 is stored in the another management apparatus 10 that is different from the one management apparatus 10 operated by the user U1 is described with reference to FIG. 22.

In this response processing, the other management apparatus 10 determines whether a request for the to-be-read device information 134 is received (step S3821). Specifically, the responder 143 of the other management apparatus 10 determines whether an instruction is given by the one management apparatus 10 operated by the user U1 to transmit the to-be-read device information 134. That is to say, the responder 143 determines whether the instruction made in step S386 of FIG. 20 is received.

When a determination is made that the request is not received (No in step S3821), the other management apparatus 10 repeats determining in step S3821 and waits until the request is received. Conversely, when a determination is made that the request is received (Yes in step S3821), the responder 143 of the other management apparatus 10 determines whether the storage 130 of the other management apparatus 10 stores the device information 134 to be read (step S3822).

When a determination is made that the to-be-read device information 134 is stored in the local storage 130 (Yes in step S3822), the responder 143 of the other management apparatus 10 reads the to-be-read device information 134 from the storage 130 (step S3823). Then the responder 143 of the other management apparatus 10 transmits the read device information 134 to the one management apparatus 10 that is the transmission source of the request (step S3824). Thereafter, the response processing ends.

When a determination is made in step S3822 that the storage 130 does not store the to-be-read device information 134 (No in step S3822), the responder 143 of the other management apparatus 10 sends a response indicating rejection of transmission of the to-be-read device information 134 (step S3825). Thereafter, the response processing ends.

As a result of execution of the reading processing of reading the device information 134 and the response processing that are described above, reading of various device information 134 stored in the management apparatuses 10 and relating to the devices 20 that are managed by the management apparatuses 10 can be achieved using a freely selected management apparatus 10.

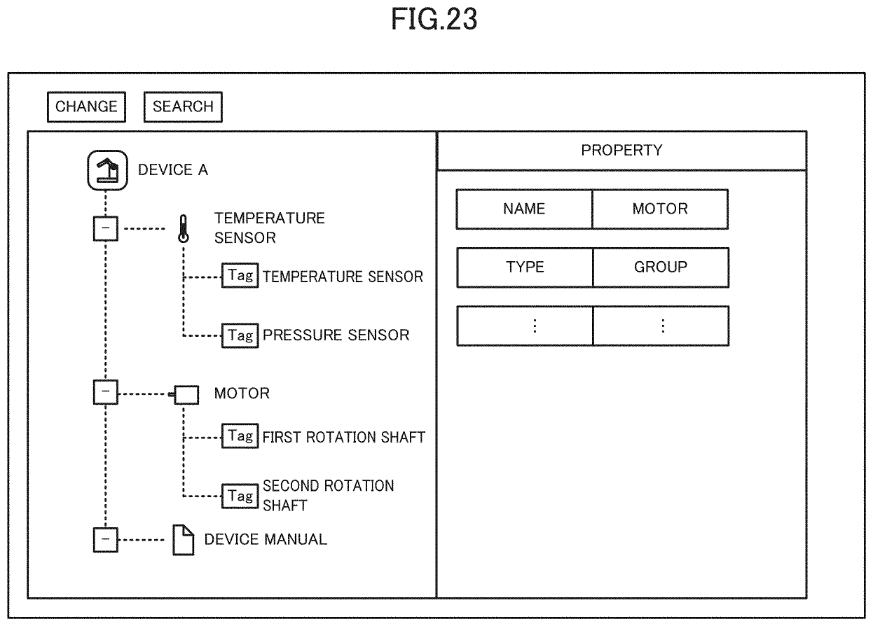

Again with reference to FIG. 12, following the reading processing for reading the device information 134 (step S38), the one management apparatus 10 determines whether a change operation by the user U1 for changing the device information 134 is made (step S39). Such change operation is made by operating the example screen illustrated in FIG. 23. In the screen of FIG. 23, the content of the device information 134 is displayed on the left side, and a form for changing the content of the device information 134 is displayed on the right side. The user can display on the right side the device information 134 of a freely selected device 20 by selecting the device 20 on the left side of the screen, and can also change the content of the form displayed on the right side by, for example, selecting by using a pull-down menu or inputting using a software keyboard.

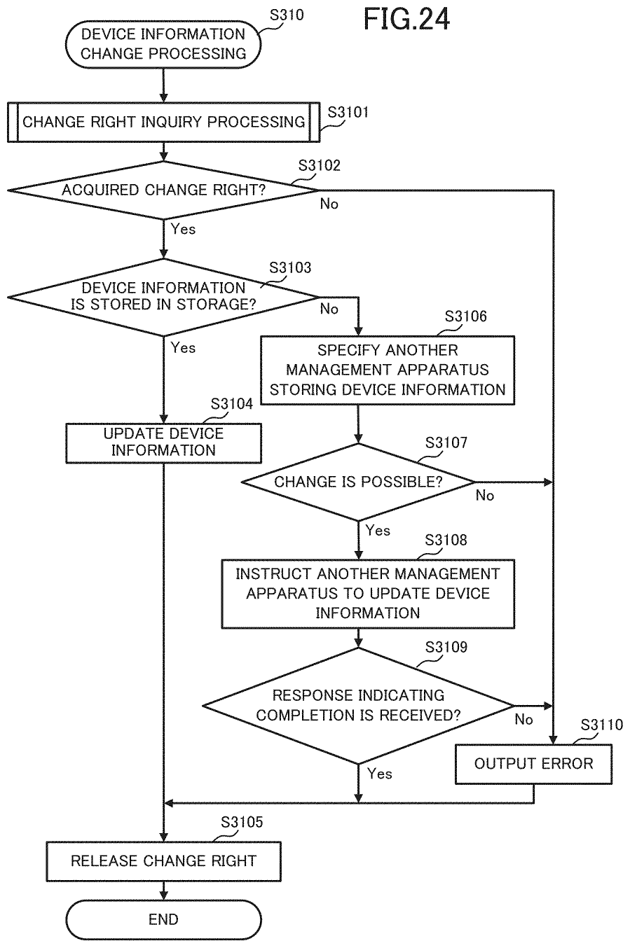

Again with reference to FIG. 12, when a determination is made in step S39 that the change operation is not made (No in step S39), the one management apparatus 10 shifts the processing to step S311. Conversely, when a determination is made that the change operation is made (Yes in step S39), the one management apparatus 10 executes change processing of changing the device information 134 (step S310). This change processing is mainly executed by the updater 142. Hereinafter, this change processing is described with reference to FIG. 24.

In the change processing for changing the device information 134, the one management apparatus 10 executes inquiry processing for inquiring about the change right (step S3101). This inquiry processing is equivalent to the inquiry processing illustrated in FIG. 15. Also, the other management apparatus 10 executes, as response processing responding to the inquiry, processing that is equivalent to the flowchart of FIG. 16.

Then the one management apparatus 10 determines whether the change right is acquired (step S3102). When a determination is made that the change right is acquired (Yes in step S3102), the one management apparatus 10 determines whether the storage 130 of the one management apparatus 10 stores the device information 134 to be changed (step S3103).

When a determination is made that the to-be-changed device information 134 is stored in the storage 130 (Yes in step S3103), the one management apparatus 10 updates the to-be-changed device information 134 in accordance with the change operation (step S3104). Thereafter, the one management apparatus 10 releases the change right (step S3105) and ends the change processing.

When a determination is made in step S3103 that the to-be-changed device information 134 is not stored in the storage 130 (No in step S3103), the one management apparatus 10 refers to the system configuration information 131 to specify another management apparatus 10 that stores the to-be-changed device information 134 (step S3106).

Then the one management apparatus 10 refers to the system configuration information 131 to determine whether changing of the to-be-changed device information 134 is possible from the one management apparatus 10 (step S3107). When a determination is made that change is possible (Yes in step S3107), the one management apparatus 10 instructs the another management apparatus 10 to update the to-be-changed device information 134 (step S3108). This instruction is performed by the instructor 144.

Then the one management apparatus 10 determines whether a response indicating completion of update of the to-be-changed device information 134 is received from the another management apparatus 10 (step S3109). When a determination is made that a completion response is received (Yes in step S3109), the one management apparatus 10 shifts the processing to step S3105.

When a determination is made in step S3102 that the change right is not acquired (No in step S3102), when a determination is made in step S3107 as change is impossible (No in step S3107), or when a determination is made in step S3109 that a completion response is not received (No in step S3109), the one management apparatus 10 outputs an error (step S3110) and shifts the processing to step S3105.

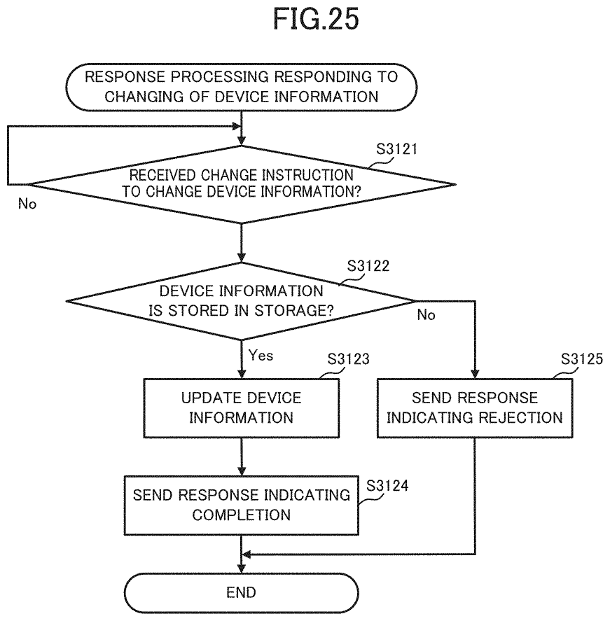

Next, response processing that is executed by the other management apparatus 10 when the to-be-changed device information 134 is stored in the another management apparatus 10 that is different from the one management apparatus 10 operated by the user U1 is described with reference to FIG. 25.

In this response processing, the other management apparatus 10 determines whether a change instruction instructing changing of the device information 134 is received (step S3121). Specifically, the responder 143 of the other management apparatus 10 determines whether the one management apparatus 10 operated by the user U1 instructs to change the device information 134. That is to say, the responder 143 of the other management apparatus 10 determines whether the instruction made in step S3108 of FIG. 24 is received.

When a determination is made that the change instruction is not received (No in step S3121), the other management apparatus 10 repeats determining in step S3121 and waits until the change request is received. Conversely, when a determination is made that the change request is received (Yes in step S3121), the responder 143 of the other management apparatus 10 determines whether the to-be-changed device information 134 is stored in the storage 130 of the other management apparatus 10 (step S3122).

When a determination is made that the to-be-changed device information 134 is stored in the storage 130 stores (Yes in step S3122), the updater 142 of the other management apparatus 10 updates this device information in accordance with the change instruction (step S3123). Then the responder 143 of the other management apparatus 10 sends, to the one management apparatus 10 that is the transmission source of the change instruction, a response indicating completion of changing (step S3124). Thereafter, the response processing ends.

When a determination is made in step S3122 that the to-be-changed device information 134 is not stored in the storage 130 (No in step S3122), the responder 143 of the other management apparatus 10 sends a response indicating rejection of transmission of the device information 134 (step S3125). Thereafter, the response processing ends.

As a result of execution of the change processing of changing the device information 134 and the response processing that are described above, changing of the device information 134 relating to the devices 20 managed separately by the various management apparatuses 10 can be achieved using a freely selected management apparatus 10.

Again with reference to FIG. 12, following step S310, the one management apparatus 10 updates display content (step S311). Specifically, the display controller 122 updates, based on the information stored in the storage 130, the content displayed on the display 110. Due to such operation, the system configuration and information relating to the devices 20 that are based on newest information are displayed to the user.

Then the one management apparatus 10 determines whether the user inputs an end operation for terminating the UI processing (step S312). When a determination is made that the end operation is not input (No in step S312), the one management apparatus 10 repeats the processing of step S31 and beyond. Conversely, when a determination is made that the end operation is input (Yes in step S312), the management apparatus 10 ends the UI processing.

As described above, the management apparatus 10 causes the display 110 to display the configuration of the system 200 such that the predetermined relationships among the devices 20 are indicated. Additionally, when the management apparatus 10 receives an operation concerning the device 20 that is the management target of the management apparatus 10, the management apparatus 10 reads and acquires the device information 134 from the storage 130, and when the management apparatus 10 receives an operation concerning the device 20 that is the management target of another management apparatus 10, the management apparatus 10 reads and acquires the device information 134 from the another management apparatus 10 and then causes the display 110 to display the acquired device information 134. This enables displaying the configuration of the system 200 for easy understanding by the user U1 and allows the user U1 to obtain the device information 134 relating to any one of the devices 20 without grasping a management target range of each management apparatus 10. Thus the management burden in operating the system 200 including numerous devices 20 can be reduced.

Furthermore, the display controller 122 reads the system configuration information 131 from the storage 130 via the accessor 140 and causes the display 110 to display the system configuration information 131. This prevents occurrence of communication delay in reading the system configuration information 131 from another management apparatus 10 and allows the user U1 to refer to the configuration of the system 200 immediately.

Furthermore, when the content of the system configuration information 131 stored in the storage 130 of the management apparatus 10 differs from the content of the system configuration information 131 managed by another management apparatus 10 and further the revision number of the system configuration information 131 stored in the management apparatus 10 is smaller than the revision number of the system configuration information 131 managed by the another management apparatus 10, the management apparatus 10 updates the system configuration information 131 stored therein. Thus each of the management apparatuses 10 can maintain the system configuration information 131 stored therein in a newest state.

Furthermore, the updater 142 updates the system configuration information 131 stored in the storage 130 when the receiver 121 receives an operation for changing the system configuration information 131. This allows the user U1 to freely define the configuration of the system 200.

Furthermore, the management apparatus 10 displays the configuration of the system 200 in a tree-like structure to indicate master-slave relationships as the relationships among the devices 20. This allows the user U1 to easily recognize the configuration of the system 200 in comparison to displaying the example table illustrated in FIG. 5.

Furthermore, when the management apparatus 10 receives from another management apparatus 10 a request for the device information 134 relating to the device 20 managed by the management apparatus 10, the management apparatus 10 provides the another management apparatus 10 with the device information 134 in response to the request. This enables decentralized management of numerous devices 20 using multiple management apparatuses 10, thereby achieving reduction in the burden for management of numerous devices 20 while allowing the user U1 to utilize any one of the multiple management apparatus 10 as a UI and to refer to the device information 134 relating to any one of the numerous devices 20 without restriction imposed by the management target range of the one management apparatus 10.

Furthermore, when the management apparatus 10 receives an operation for changing the device information 134 relating to the device 20 managed by another management apparatus 10, the management apparatus 10 instructs the another management apparatus 10 to change the device information 134. This allows the user U1 to utilize any one of the management apparatuses 10 as a UI and to change the device information 134 relating to any one of the devices 20 without restriction imposed by the management target range.

Although an embodiment of the present disclosure is described above, the present disclosure is not limited to the above-described embodiment.

For example, a profile may be used in storing the device information 134 in the storage 130. The profile is data that includes specifications for the device (including a vendor name, model name, a size, and power supply capacity) and I/O assignment information (including a sensor name and a shaft name of a motor) and in which such information is hierarchically represented. For example, the processor unit 120 may acquire a profile from the device 20 via the second communicator 152 in accordance with an operation that is input into the screen by the user U1 to change the device information 134, and may append the acquired profile, as the device information 134, to the existing device information 134. When the content of the acquired profile is the same as the content of the existing device information 134, the processor unit 120 does not overwrite the existing device information 134 with the captured profile and instead adds the acquired profile as new device information 134. Further, the processor unit 120 can read multiple profiles for one device. Using such profiles allows the user U1 to save the trouble of understanding the specification of the device 20 in creating the device information 134.

Furthermore, the device information 134 includes I/O addresses of the sensors and the motors, such as “D0”, “D1”, “X1”, and “X2” illustrated in FIG. 9. Reading and writing of values indicated by such I/O addresses may be performed using the screen of the display 110 or using OPC UA provided by the processor unit 120 (an OPC UA I/F or an OPC UA API). Further, in a case where the device information 134 is file-type information, this file may be run by use of a tool with which an operating system (OS) associates the file when the name of this file is selected.

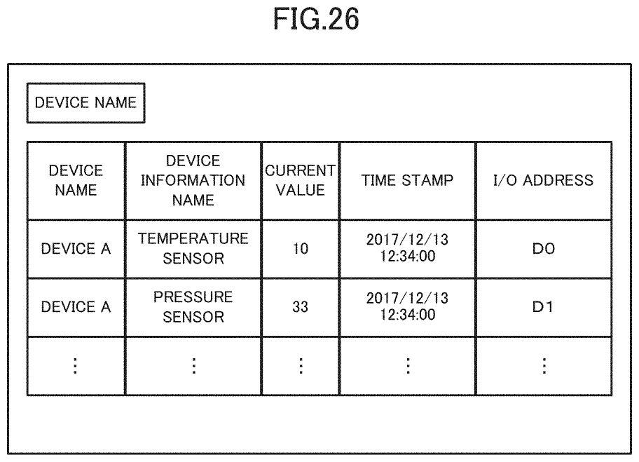

FIG. 26 illustrates an example of the screen for displaying I/O addresses. In this screen, a device name, a device information name, a current value of the device information, a time stamp indicating a time on which the device information is acquired, and an I/O address indicating location of the device information, are displayed in order from the leftmost column. Moving a cursor to the current value causes switching to an input mode, and inputting a value in this mode can rewrite the current value of the device.

Furthermore, although the system 200 of above-described embodiment includes the devices 20 and does not include the management apparatuses 10, this configuration is not limiting. The management system 100 including the management apparatuses 10 may be treated as the management system 200. Further, the relationships among the management apparatuses 10 and the devices 20 may be defined to indicate a management target range of each management apparatus 10. Further, the system 200 may include only a management apparatus 10 that the user U1 uses as the UI. Further, the system 200 may include at least one of the one management apparatus 10 or the other management apparatus 10.

Furthermore, although the management apparatus 10 includes a built-in storage 130, such configuration is not limiting. For example, an external server device may be employed to store at least one of the system configuration information 131, the update status information 132, the connection information and the device information 134, or the management apparatus 10 may treat, as equivalent to the storage 130 according to the above-described embodiment, (i) the server device only or (ii) both the server device and the built-in storage 130.

Furthermore, the functions of the management apparatus 10 can be achieved by dedicated hardware or by a normal computer system.

For example, distributing the program P1 to be executed by the processor 101 by storing the program P1 in a non-transitory computer-readable recording medium and then installing the program P1 in a computer can achieve an apparatus for executing the above-described processing. Examples of such a recording medium are a flexible disk, a compact disc read-only memory (CD-ROM), a digital versatile disc (DVD), and a magneto-optical (MO) Disc.

Furthermore, the program P1 may be stored in a disk device included in a server device on a communication network such as the Internet and may be downloaded onto a computer, for example, by superimposing the program on a carrier wave.

Furthermore, the above-described processing can also be achieved by starting and executing the program P1 while transferring the program P1 through the communication network.

Furthermore, the above-described processing can also be achieved by executing all or a portion of the program P1 on the server device and by executing, using the computer, the program while transmitting and receiving information related to the processing via the communication network.

In the case where the above-described functions are implemented by an operating system (OS) by allotment to the OS or are implemented by cooperation between the OS and an application, for example, storage and distribution on the medium of only portions of the program P1 other than a portion of the program P1 executed by the OS is permissible. Alternatively, such portions of the program P1 may be downloaded to a computer.

Furthermore, the means for achieving the functions of the management apparatus 10 is not limited to software, and a part of or all of the functions may be achieved by dedicated hardware including a circuit.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for management of a system including numerous devices.

### REFERENCE SIGNS LIST

100 Management system
10-13 Management apparatus
20-26 Device
30 Network
31 Bus
101 Processor
102 Main storage
103 Auxiliary storage
104 Inputter
105 Outputter
106 Communicator
107 Internal bus
110 Display
120 Processor unit
121 Receiver
122 Display controller
130 Storage
131 System configuration information
132 Update status information
133 Connection information
134 Device information
140 Accessor
141 Acquirer
142 Updater
143 Responder
144 Instructor
151 First communicator
152 Second communicator
200 System
1342 Device information
P1 Program
U1 User

1. A management apparatus for connecting to a management target device and to another management apparatus via a network, the management apparatus comprising:
a display controller to cause a display to display a configuration of a system including the management target device and another management target device managed by the another management apparatus such that a predefined relationship between the management target devices is indicated;
a receiver to receive an operation for obtaining device information relating to the management target devices included in the system;
(i) an acquirer to acquire, when the receiver receives an operation for obtaining the device information relating to the management target device, the device information relating to the management target device by reading the device information relating to the management target device from a storage and (ii) acquire, when the receiver receives an operation for obtaining the device information relating to the another management target device managed by the another management apparatus, the device information relating to the another management target device from the another management apparatus; and
an updater to update, when content of system configuration information stored in the storage differs from content of another system configuration information stored in the another management apparatus, the system configuration information stored in the storage, the system configuration information indicating the configuration of the system including the relationship between the management target devices, wherein
the display controller reads the system configuration information from the storage, causes the display to display the configuration of the system, and causes the display to display the device information acquired by the acquirer.

2. The management apparatus according to claim 1, further comprising:
the storage to store (i) the device information relating to the management target device and (ii) the system configuration information, wherein
the system includes at least one of the management apparatus or the another management apparatus.

3.-4. (canceled)

5. The management apparatus according to claim 1, wherein
the receiver receives an operation for changing the system configuration information, and
the updater, when the receiver receives the operation for changing the system configuration information, updates the system configuration information stored in the storage, in accordance with the operation for changing the system configuration information.

6. The management apparatus according to claim 1, wherein
the relationship between the management target devices is a master-slave relationship between the management target devices, and
the display controller displays the configuration of the system in a tree-like structure.

7. The management apparatus according to claim 1, further comprising:
a responder to, when the another management apparatus requests the device information relating to the management target device, respond to the request by providing the another management apparatus with the requested device information relating to the management target device.

8. A management apparatus for connecting to a management target device and to another management apparatus via a network, the management apparatus comprising:
a display controller to cause a display to display a configuration of a system including the management target device and another management target device managed by the another management apparatus such that a predefined relationship between the management target devices is indicated;
a receiver to receive an operation for obtaining device information relating to the management target devices included in the system;
an acquirer to (i) acquire, when the receiver receives an operation for obtaining the device information relating to the management target device, the device information relating to the management target device by reading the device information relating to the management target device from a storage and (ii) acquire, when the receiver receives an operation for obtaining the device information relating to the another management target device managed by the another management apparatus, the device information relating to the another management target device from the another management apparatus; and
an instructor to provide the another management apparatus with an instruction, wherein
the display controller causes the display to display the device information acquired by the acquirer,
the receiver receives an operation for changing the device information relating to the another management target device managed by the another management apparatus, and
the instructor, when the receiver receives the operation for changing the device information, instructs the another management apparatus to change the device information.

9. A management system comprising:
the management apparatus according to claim 1;
the management target device that is to connect to the management apparatus via the network and is managed by the management apparatus; and
the another management apparatus to connect to the management apparatus via the network.

10.-12. (canceled)

13. A management system comprising:
the management apparatus according to claim 8;
the management target device that is to connect to the management apparatus via the network and is managed by the management apparatus; and
the another management apparatus to connect to the management apparatus via the network.
